(19) United States
(12) Patent Application Publication
(10) Pub. No.: US 2024/0257299 A1
(43) Pub. Date: Aug. 1, 2024

(54) METHOD FOR PROCESSING TEXT IMAGES AND APPARATUS THEREFOR, AND STORAGE MEDIUM

(71) Applicant: Glenfly Tech Co., Ltd., Shanghai (CN)

(72) Inventor: Yiding XU, Shanghai (CN)

(21) Appl. No.: 18/425,878

(22) Filed: Jan. 29, 2024

(30) Foreign Application Priority Data
Jan. 31, 2023 (CN) 202310085442.X

(51) Int. Cl. G06T 3/40; G06T 7/90; G06T 9/00

(52) U.S. Cl. CPC G06T 3/40; G06T 7/90; G06T 9/00; G06T 2207/10024

(57) ABSTRACT

A method for processing text images, an apparatus therefor, a device and a storage medium are provided. The method includes: obtaining an initial text image; extracting luminance and chrominance of the initial text image; obtaining coefficients of chrominance transformation by performing a linear transformation on the chrominance based on the luminance; and obtaining a to-be-displayed text image based on the coefficients of chrominance transformation. Luminance values of the text image are integrated into output chrominance values. There is no lack of data about the luminance values during a display process, thereby avoiding blurring and color distortion problems caused by traditional chroma upsampling algorithm and improving display effect.

This application claims priority under 35 U.S.C. § 119 to Chinese Patent Application No. 202310085442.X, filed on Jan. 31, 2023, the entire content of which is incorporated herein in its entirety.

### TECHNICAL FIELD

The present application relates to the technical field of image processing, and more particularly, relates to a method for processing text images, an apparatus therefor, a device and a storage medium.

### BACKGROUND

Like RGB color model, YUV is also a way of color coding. Principle of YUV color coding is to separate luminance from chrominance and perform downsampling on chrominance information since human eyes are more sensitive to luminance than chrominance, thereby saving space for storing videos and saving video bandwidth. Usually, images in ratio YUV444 may be chroma-downsampled to ratios such as YUV422 and YUV420. Since a display cannot directly display images in YUV422 and YUV420, chrominance needs to be upsampled to the same size as luminance, i.e., images need to be chroma-upsampled to ratio YUV444, and then converted into RGB format to be displayable on the screen.

In terms of processing video data, traditional chroma upsampling algorithm based on linear interpolation or spline curve interpolation already achieves comparatively good results. However, in telecommuting, for data in text-based office scenarios such as on a cloud desktop, as texture of characters changes dramatically, severe text blurring and color distortion may be resulted in case of utilizing the traditional chroma upsampling algorithm, and the display effect may be adversely affected.

### SUMMARY

In view of the defects mentioned above, a method for processing text images and an apparatus therefor, a device and a storage medium are provided to resolve the problem that, in telecommuting, for data in text-based office scenarios such as on a cloud desktop, as texture of characters changes dramatically, severe text blurring and color distortion may be resulted in case of utilizing the traditional chroma upsampling algorithm, and the display effect may be adversely affected.

In a first aspect, a method for processing text images is provided by the present disclosure, the method includes:
obtaining an initial text image;
extracting luminance and chrominance of the initial text image;
obtaining coefficients of chrominance transformation by performing a linear transformation on the chrominance based on the luminance; and
obtaining a to-be-displayed text image based on the coefficients of chrominance transformation.

In accordance with an embodiment, the obtaining the coefficients of chrominance transformation by performing the linear transformation on the chrominance based on the luminance includes:
obtaining a way of sampling of the initial text image;
downsampling the luminance based on the way of sampling; and
obtaining the coefficients of chrominance transformation by performing the linear transformation on the chrominance based on the downsampled luminance, where a size of the downsampled luminance is the same as a size of the chrominance.

In accordance with an embodiment, the obtaining the coefficients of chrominance transformation by performing the linear transformation on the chrominance based on the downsampled luminance includes:
constructing a guided filter;
taking the downsampled luminance as a guidance image of the guided filter and taking the chrominance as an input image of the guided filter;
calculating linear coefficients by using the guided filter based on the guidance image and the chrominance; and
obtaining the coefficients of chrominance transformation by performing transformation on the chrominance based on the linear coefficients.

In accordance with an embodiment, the calculating the linear coefficients based on the guidance image and the chrominance includes:
performing a linear transformation on the guidance image to obtain a guided output image;
obtaining a target function based on the guided output image and the chrominance; and,
optimizing the target function to find an optimal solution and obtaining the linear coefficients.

In accordance with an embodiment, the obtaining the to-be-displayed text image based on the coefficients of chrominance transformation includes:
upsampling the coefficients of chrominance transformation;
obtaining an output image based on the upsampled coefficients of chrominance transformation and the luminance; and
converting an encoding mode of the output image and obtaining the to-be-displayed text image.

In accordance with an embodiment, the upsampling the coefficients of chrominance transformation includes:
upsampling the linear coefficients corresponding to the chrominance transformation and enlarging sizes of the linear coefficients to a same size as the luminance.

In a second aspect, an apparatus for processing text images is further provided by the present disclosure, and the apparatus includes:
an obtaining module, which is configured to obtain an initial text image;
an extraction module, which is configured to extract luminance and chrominance of the initial text image; and
a processing module, which is configured to: obtain coefficients of chrominance transformation by performing a linear transformation on the chrominance based on the luminance, and obtain a to-be-displayed text image based on the coefficients of chrominance transformation.

In a third aspect, a computer device is further provided by the present disclosure. The compute device includes a memory and a processor, and a computer program is stored in the memory. Steps of the method for processing text images in the first aspect are implemented by the processor when the computer program is executed by the processor.

In a fourth aspect, a computer readable storage medium is further provided by the present disclosure, and a computer program is stored thereon. Steps of the method for processing text images in the first aspect are implemented when the computer program is executed by a processor.

In a fifth aspect, a computer program product is further provided by the present disclosure. The computer program product includes a computer program. Steps of the method for processing text images in the first aspect are implemented when the computer program is executed by a processor.

The above-mentioned method and apparatus for processing text images, the device and the storage medium possess at least the following benefits.

In the present disclosure, the luminance and the chrominance of the initial text image are extracted after the initial text image is obtained, and linear transformation is performed on the chrominance based on the luminance, such that luminance values of the text image may be integrated into outputted chrominance values. There is no lack of data about the luminance values during a display process, thereby avoiding blurring and color distortion problems caused by traditional chroma upsampling algorithms, and improving a display effect.

### BRIEF DESCRIPTION OF THE DRAWINGS

The drawings, as a part of the present disclosure, are accompanied for better understanding of the present disclosure. Exemplary embodiments of the present disclosure and the descriptions thereof are used to explain the present disclosure rather than to constitute any undue limitation to the present disclosure.

To describe technical solutions of the embodiments of this disclosure more clearly, the following briefly introduces the accompanying drawings used when describing the embodiments. Apparently, the following introduced accompanying drawings are only for some embodiments of this disclosure, while other accompanying drawings can stilled be derived by those of ordinary skills in the art from these introduced accompanying drawings without paying any creative effort.

FIG. 1 is a schematic flowchart of a method for processing text images according to an embodiment;

FIG. 2 is a schematic flowchart of obtaining coefficients of chrominance transformation according to an embodiment;

FIG. 3 is a structural block diagram of an apparatus for processing text images according to an embodiment;

FIG. 4. is a schematic diagram of mean filtering accessing according to an embodiment; and

FIG. 5 is an internal structure diagram of a computer device according to an embodiment.

### DETAILED DESCRIPTION OF THE EMBODIMENTS

The following describes implementations of the present disclosure through specific examples, and those skilled in the art may easily understand other advantages and effects of the present disclosure from the content disclosed in this specification. The present disclosure may also be implemented or applied through other different specific implementations. Various details in this specification may also be modified or changed based on different viewpoints and applications without departing from the spirit of the present disclosure. It should be noted that the following embodiments and the features in the embodiments may be combined with each other if no conflict presents.

For illustrative purposes, some exemplary embodiments of the present disclosure are described. It needs to be understood that the present disclosure may be implemented through other means that are not specifically shown in the accompanying drawings.

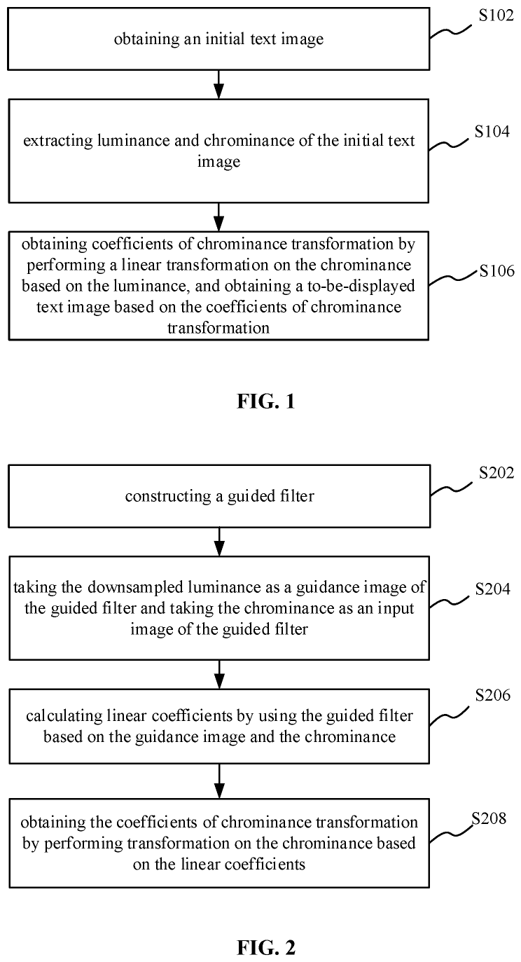

Reference may be made to FIG. 1, a method for processing text images is provided according to an embodiment of the present disclosure, which specifically includes steps S102 to S106 as follows.

Step S102 includes: obtaining an initial text image.

Specifically, images are displayed in RGB coding mode on an image display. In order to save bandwidth and improve data processing efficiency in the fields of audio, video, image and the like, image data is converted from RGB coding mode to YUV coding mode for transmission, and then converted back to RGB coding mode for display. The initial text image obtained according to the embodiment is a color image and is already converted into the YUV coding mode. Y represents a luminance value, which is a grayscale value. U and V represent chrominance values, which describe image color and saturation. U and V are used to specify a color of a pixel. The initial text image includes multiple rows and multiple columns of pixels, where data of each pixel includes a luminance value and chrominance values. That is, YUV coding consists of a Y component, a U component and a V component.

Step S104 includes: extracting luminance and chrominance of the initial text image.

Specifically, the YUV coding mode may reduce a bandwidth of the chrominance. A number of samples of the luminance value Y in a video is not changed while numbers of samples of the chrominance value U and the chrominance value V are reduced. In general, ways of sampling of the YUV coding mode may include, according to proportions of the luminance value Y, the chrominance value U and the chrominance value Y, YUV444, YUV422 and YUV 420. For YUV444, each luminance value Y corresponds to one pair of chrominance values U and V, each pixel occupies 3 bytes, that is Y+U+V=8+8+8=24bits, and when scanning each pixel, a sampling rate of each sampling component is not reduced. For YUV 422, every two luminance values Y share one pair of chrominance values U and V, each pixel occupies 2 bytes, that is Y+0.5U+0.5V=8+4+4=16bits, and a ratio of the sampling rate of the luminance value Y to the sampling rate of the chrominance values U and V in a horizontal direction is 2:1 while sampling rates in a vertical direction are not reduced. For YUV 420, every four luminance values Y share one pair of chrominance values U and V, each pixel occupies 1.5 bytes, that is Y+0.25U+0.25V=8+2+2=12bits, and a ratio of the sampling rate of the luminance value Y to the sampling rate of the chrominance values U and V in each of the horizontal direction and the vertical direction is 2:1.

Furthermore, extracting the luminance of the initial text image includes:
obtaining the luminance by iterating through respective pixels in the initial text image and sequentially extracting luminance values Y of the respective pixels in the initial text image.

Further, extracting the chrominance of the initial text image includes: obtaining the chrominance by iterating through respective pixels in the initial text image and sequentially extracting chrominance values U and chrominance values V of respective pixels.

Step S106 includes: obtaining coefficients of chrominance transformation by performing a linear transformation on the chrominance based on the luminance, and obtaining a to-be-displayed text image based on the coefficients of chrominance transformation.

Specifically, a first-order linear model is established for every pixel in the initial text image. The first-order linear model fits a mapping relationship between a luminance value Y and chrominance values U and V of a current pixel. In this way, luminance values of the text image may be integrated into output chrominance values.

For further illustration, obtaining the coefficients of chrominance transformation by performing the linear transformation on the chrominance based on the luminance includes the following processes.

A way of sampling of the initial text image is obtained. In general, the way of sampling may be the above-mentioned YUV422 or YUV420.

The extracted luminance is downsampled based on the way of sampling so that a size of the downsampled luminance is the same as a size of the chrominance. When the way of sampling is YUV422, a corresponding calculation formula for downsampling is:

$${Y}_{DS} = ( {Y}_{00} + {Y}_{10} ) * \frac{1}{2} .$$

When the way of sampling is YUV420, a corresponding calculation formula of downsampling is:

$${Y}_{DS} = ( {Y}_{00} + {Y}_{01} + {Y}_{10} + {Y}_{11} ) * \frac{1}{4} .$$

Here, Y_{DS} is the luminance after downsampling, Y₀₀ to Y₁₁ are luminance values.

Further, the coefficients of chrominance transformation are obtained by performing the linear transformation on the chrominance based on the downsampled luminance, which may include the following steps S202 to S208.

Step S202 includes: constructing a guided filter.

Step S204 includes: taking the downsampled luminance as a guidance image of the guided filter and taking the chrominance as an input image of the guided filter.

Step S206 includes: calculating linear coefficients by using the guided filter based on the guidance image and the chrominance.

Step S208 includes: obtaining the coefficients of chrominance transformation by performing transformation on the chrominance based on the linear coefficients.

Specifically, a basic assumption of the guided filter is that a filtering output is a local linear transformation of the guidance image. Through a given guidance image and a given input image, linear coefficients may be calculated. The calculation may include the following process.

In response to taking the luminance as the guidance image, a linear transformation is performed on the guidance image to obtain a guided output image. For any position k in an image, a filtering window is wₖ, and an expression of the guided output image is: qᵢ=Σ_{k:i∈w}_{ₖ} aₖ*Iᵢ+bₖ, i∈wₖ; where, qᵢ is the guided output image, Iᵢ is the guidance image.

A target function is obtained based on the guided output image and the chrominance, where the target function is a difference between the input image and the output image. To ensure that the input image is roughly the same as the output image locally, the target function is optimized to find an optimal solution that minimizes a mean square error between the input image and the output image. The minimum of the mean square error is expressed as: E=min Σ_{i∈w}_{ₖ}((aₖ·Iᵢ+bₖ−Pᵢ)²+∈·aₖ²); where, e is a configured constant that is used to avoid division by zero and to adjust aₖ and bₖ.

A partial derivative of aₖ and a partial derivative of bₖ are solved as follows:

$$\frac{\partial E}{\partial {b}_{k}} = {\sum }_{i ∈ {w}_{k}} 2 {b}_{k} + 2 ( {a}_{k} {I}_{i} - {p}_{i} ) ,$$

$$\frac{\partial E}{\partial {b}_{k}} = {\sum }_{i ∈ {w}_{k}} ( 2 {I}_{i}^{2} \cdot {a}_{k} + 2 ( {b}_{k} - {p}_{i} ) \cdot {I}_{i} + 2 ϵ \cdot {a}_{k} ) .$$

The partial derivative of bₖ is set to be 0: Σ_{i∈w}_{ₖ} bₖ=Σ_{i∈w}_{ₖ} Pᵢ−Σ_{i∈w}_{ₖ} aₖIᵢ; and the partial derivative to of ax is set to be 0: Σ_{i∈w}_{ₖ} (Iᵢ²·aₖ+∈·aₖ)=Σ_{i∈w}_{_{K}} (Iᵢ·Pᵢ−Iᵢ·bₖ).

For further illustration, the guided filter further includes a mean filter which is used to perform mean filtering on the aₖ and bₖ obtained from the above-mentioned calculation to obtain linear coefficients a and b corresponding to the chrominance value U in the chrominance and linear coefficients a and b corresponding to the chrominance value V in the chrominance, which may be expressed as follows:

$${b}_{k} = {mean ( p )}^{{W}_{k}} - {a}_{k} \cdot {mean ( I )}^{{W}_{k}} , {\sum }_{i ∈ {w}_{k}} ( {I}_{i}^{2} \cdot {a}_{k} + ϵ \cdot {a}_{k} ) = {\sum }_{i ∈ {w}_{k}} ( {I}_{i} \cdot {p}_{i} - {I}_{i} \cdot ( {mean ( p )}^{{W}_{k}} - {a}_{k} \cdot {mean ( I )}^{{W}_{k}} ) ) , {a}_{k} \cdot {\sum }_{i ∈ {w}_{k}} ( {I}_{i}^{2} + ϵ - {I}_{i} \cdot {mean ( I )}^{{W}_{k}} ) = {\sum }_{i ∈ {w}_{k}} ( {I}_{i} \cdot {p}_{i} - {I}_{i} \cdot {mean ( p )}^{{W}_{k}} ) , {a}_{k} [ {\sum }_{i ∈ {w}_{k}} {I}_{i}^{2} + {\sum }_{i ∈ {w}_{k}} ϵ - {mean ( I )}^{{W}_{k}} \cdot {\sum }_{i ∈ {w}_{k}} {I}_{i} ] = {\sum }_{i ∈ {w}_{k}} ( {I}_{i} \cdot {p}_{i} ) - {\sum }_{i ∈ {w}_{k}} {I}_{i} \cdot {mean ( p )}^{{W}_{k}} , {a}_{k} [ {mean ( {I}^{2} )}^{{W}_{k}} + ϵ - {mean ( I )}^{{W}_{k}} \cdot {mean ( I )}^{{W}_{k}} ] = {mean ( I \cdot p )}^{{W}_{k}} - {mean ( I )}^{{W}_{k}} \cdot {mean ( p )}^{{W}_{k}} .$$

According to following formulas about expectation, variance and covariance: Var(X)=E[x²]−E[X]² and Cov(X, Y)=E[XY]−E[X]·E[Y], the following may be obtained:

$${a}_{k} \cdot ( Var {( I )}^{{W}_{k}} + ϵ ) = {Cov ( I , p )}^{{W}_{k}} , {a}_{k} = \frac{{Cov ( I , p )}^{{W}_{k}}}{( {Var ( I )}^{{W}_{k}} + ϵ} .$$

According to the embodiment, the guidance image I is the downsampled luminance Y_{DS}, and the input image is the chrominance. Therefore, the linear coefficients a and b corresponding to the chrominance value U in the chrominance and the linear coefficients a and b corresponding to the chrominance value V in the chrominance may be expressed as follows:

$${a}_{U} = \frac{{f}_{mean} ( {Y}_{DS} \cdot U ) - {f}_{mean} ( {Y}_{DS} ) \cdot {f}_{mean} ( U )}{{f}_{mean} ( {Y}_{DS}^{2} ) - {{f}_{mean} ( {Y}_{DS} )}^{2} + ϵ} ,$$

$${b}_{U} = {f}_{mean} ( U ) - {a}_{U} \cdot {f}_{mean} ( {Y}_{DS} ) ,$$

$${a}_{V} = \frac{{f}_{mean} ( {Y}_{DS} \cdot V ) - {f}_{mean} ( {Y}_{DS} ) \cdot {f}_{mean} ( V )}{{f}_{mean} ( {Y}_{DS}^{2} ) - {{f}_{mean} ( {Y}_{DS} )}^{2} + ϵ} ,$$

$${b}_{V} = {f}_{mean} ( V ) - {a}_{V} \cdot {f}_{mean} ( {Y}_{DS} ) .$$

Here, fₘₑₐₙ represents mean filtering, whose size may be configured based on needs, for example, the size of mean filtering may be 3×3 or 5×5.

For further illustration, obtaining the to-be-displayed text image based on the coefficients of chrominance transformation may include the following processes.

The coefficients of chrominance transformation are upsampled, and an output image is obtained based on the upsampled coefficients and luminance. At this time, the output be as: image q may expressed

$$q = {f}_{mean} ( a ) \cdot I + {f}_{mean} ( b )$$

Accordingly, output chrominance value U and output chrominance value V may be expressed by following formulas:

$${U}_{out} = {f}_{mean} ( {a}_{U} ) \cdot Y + {f}_{mean} ( {b}_{U} ) ,$$

$${V}_{out} = {f}_{mean} ( {a}_{V} ) \cdot Y + {f}_{mean} ( {b}_{V} ) .$$

Specifically, linear coefficients a and b corresponding to the chrominance transformation are upsampled, and sizes of the linear coefficients are enlarged to a same size as the luminance. It should be understood that there are many mature solutions for image upsampling algorithms in existing technologies, such as bilinear interpolation, bicubic interpolation, Lanczos interpolation, or Bezier curve interpolation. An appropriate algorithm may be selected according to resources in practical applications. According to the embodiment, bicubic interpolation is used.

Encoding mode of the output image is converted, and the upsampled coefficients of chrominance transformation and the luminance are substituted into the following mode conversion formula to obtain the to-be-displayed text image:

$$\{ \begin{matrix}R = Y + 1.14 * {V}_{out} \\ G = Y - 0.39 * {U}_{out} - 0.58 * {V}_{out} \\ B = Y + 2.03 * {U}_{out}\end{matrix}$$

In the above-mentioned method for processing text images, the finally outputted chrominance values U and V are represented as linear functions of Y. According to the above-mentioned formula, each pixel corresponds to one first-order linear model, where a and b are linear parameters of the linear model. Each first-order linear model fits a mapping relationship between the luminance value Y and the chrominance values U and V of a current pixel, where a range of fitted data is a range of mean filtering for a and b. In the absence of a regularization term, a mean value within the range is a value with a smallest fitting error within the range. Therefore, fₘₑₐₙ (a) and fₘₑₐₙ (b) are the linear parameters with the smallest fitting error within a current range. That is to say, the chrominance values U and the chrominance values V eventually outputted by the algorithm are not obtained through interpolation, but obtained through fitting mapping relationships between Y and UV by respective local first-order linear models. In different ways of sampling, whether it is YUV420 or YUV422, there is no lack of data about Y, thereby avoiding blurring and color distortion problems caused by traditional chroma upsampling algorithms.

It is to be understood that, although steps in the flow charts involved in the above-mentioned embodiments are displayed in sequence based on indication of arrows, these steps are not necessarily executed sequentially based on the sequence indicated by the arrows. Unless otherwise explicitly specified herein, sequence to execute the steps is not strictly limited, and the steps may be executed in other sequences. In addition, at least some steps in in the flow charts involved in the above-mentioned embodiments may include multiple sub-steps or multiple stages, and these sub-steps or stages are not necessarily executed at the same moment, but may be executed at different moments. These sub-steps or stages are not necessarily executed in sequence, but may be executed in turn or alternately with another step or at least a part of sub-steps or stages of another step.

Based on a same inventive concept, an apparatus for processing text images, which may implement the above-mentioned method for processing text images, is further provided according to an embodiment of the present disclosure. The implementation solution for solving the problem provided by the apparatus is similar to the implementation solution described in the above-mentioned method. Therefore, specific limitations in one or more embodiments provided below directed to the apparatus for processing text images may be referred to the limitations of the above-mentioned method for processing text images, hence are not repeated herein.

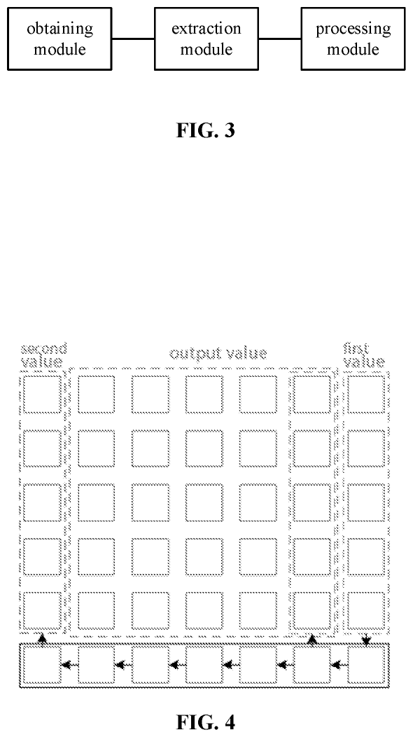

Reference may be made to FIG. 3, an apparatus for processing text images is provided according to an embodiment of the present disclosure, which includes an obtaining module, an extraction module and a processing module.

The obtaining module is configured to obtain an initial text image.

Specifically, images are displayed in RGB coding mode on an image display. In order to save bandwidth and improve data processing efficiency in the fields of audio, video, image and the like, image data is converted from RGB coding mode to YUV coding mode for transmission, and then converted back to RGB coding mode for display. The initial text image obtained by the obtaining module according to the embodiment is a color image and is already converted into the YUV coding mode. Y represents a luminance value, which is a grayscale value. U and V represent chrominance values, which describe image color and saturation. U and V are used to specify a color of a pixel. The initial text image includes multiple rows and multiple columns of pixels, where data of each pixel includes a luminance value and chrominance values. That is, YUV coding consists of a Y component, a U component and a V component.

The extraction module is configured to extract luminance and chrominance of the initial text image.

Specifically, the YUV coding mode may reduce a bandwidth of the chrominance. A number of samples of the luminance value Y in a video is not changed while numbers of samples of the chrominance value U and the chrominance value V are reduced. In general, ways of sampling of the YUV coding mode may include, according to proportions of the luminance value Y, the chrominance value U and the chrominance value Y, YUV444, YUV422 and YUV 420.

For further illustration, the extraction module may extract the luminance of the initial text image as follows:

obtain the luminance by iterating through respective pixels in the initial text image and sequentially extracting luminance values Y of the respective pixels in the initial text image.

Further, extracting the chrominance of the initial text image includes: obtaining the chrominance by iterating through respective pixels in the initial text image and sequentially extracting chrominance values U and chrominance values V of respective pixels.

The processing module is configured to obtain coefficients of chrominance transformation by performing a linear transformation on the chrominance based on the luminance, and is further configured to obtain a to-be-displayed text image based on the coefficients of chrominance transformation.

Specifically, a first-order linear model is established for every pixel in the initial text image. The first-order linear model fits a mapping relationship between a luminance value Y and chrominance values U and V of a current pixel. In this way, luminance values of the text image may be integrated into output chrominance values.

For further illustration, the processing module may obtain the coefficients of chrominance transformation by performing the linear transformation on the chrominance based on the luminance as follows.

A way of sampling of the initial text image is obtained. In general, the way of sampling may be the above-mentioned YUV422 or YUV420.

The extracted luminance is downsampled based on the way of sampling so that a size of the downsampled luminance is the same as a size of the chrominance. When the way of sampling is YUV422, a corresponding calculation formula for downsampling is:

$${Y}_{DS} = ( {Y}_{00} + {Y}_{10} ) * \frac{1}{2} .$$

When the way of sampling is YUV420, a corresponding calculation formula of downsampling is:

$${Y}_{DS} = ( {Y}_{00} + {Y}_{01} + {Y}_{10} + {Y}_{11} ) * \frac{1}{4} .$$

Here, Y_{DS} is the luminance after downsampling, Y₀₀ to Y₁₁ are luminance values.

Further, the processing module obtains the coefficients of chrominance transformation by performing the linear transformation on the chrominance based on the downsampled luminance, which may include the following steps.

Step 1 includes: constructing a guided filter.

Step 2 includes: taking the downsampled luminance as a guidance image of the guided filter and taking the chrominance as an input image of the guided filter.

Step 3 includes: calculating linear coefficients by using the guided filter based on the guidance image and the chrominance.

Step 4 includes: obtaining the coefficients of chrominance transformation by performing transformation on the chrominance based on the linear coefficients.

Specifically, a basic assumption of the guided filter is that a filtering output is a local linear transformation of the guidance image. Through a given guidance image and a given input image, linear coefficients may be calculated. The calculation may include the following process.

In response to taking the luminance as the guidance image, a linear transformation is performed on the guidance image to obtain a guided output image. For any position k in an image, a filtering window is wₖ, and an expression of the guided output image is: qᵢ=Σ_{k:i∈w}_{ₖ} aₖ*Iᵢ+bₖ, i∈wₖ; where, qᵢ is the guided output image, Iᵢ is the guidance image.

A target function is obtained based on the guided output image and the chrominance, where the target function is a difference between the input image and the output image. To ensure that the input image is roughly the same as the output image locally, the target function is optimized to find an optimal solution that minimizes a mean square error between the input image and the output image. The minimum of the mean square error is expressed as: E=min Σ_{i∈w}_{ₖ}((aₖ·Iᵢ+bₖ−Pᵢ)²+∈·aₖ²); where, ∈ is a configured constant that is used to avoid division by zero and to adjust aₖ and bₖ.

A partial derivative of aₖ and a partial derivative of bₖ are solved as follows:

$$\begin{matrix}\frac{δ E}{δ {b}_{k}} = {\sum }_{i ∈ {w}_{k}} 2 {b}_{k} + 2 ( {a}_{k} {I}_{i} - {p}_{i} ) , \\ \frac{δ E}{δ {a}_{k}} = {\sum }_{i ∈ {w}_{k}} ( 2 {I}_{i}^{2} \cdot {a}_{k} + 2 ( {b}_{k} - {p}_{i} ) \cdot {I}_{i} + 2 ϵ \cdot {a}_{k} ) .\end{matrix}$$

The partial derivative of bₖ is set to be 0: Σ_{i∈w}_{ₖ} bₖ=Σ_{i∈w}_{ₖ} Pᵢ−Σ_{i∈w}_{ₖ} aₖIᵢ; and the partial derivative to of aₖ is set to be 0: Σ_{i∈w}_{ₖ} (Iᵢ²·aₖ+∈·aₖ)=Σ_{i∈w}_{_{K}} (Iᵢ·Pᵢ−Iᵢ·bₖ).

For further illustration, the guided filter further includes a mean filter which is used to perform mean filtering on the aₖ and bₖ obtained from the above-mentioned calculation to obtain linear coefficients a and b corresponding to the chrominance value U and linear coefficients a and b corresponding to the chrominance value V, which may be expressed as follows:

$${b}_{k} = {mean ( p )}^{{W}_{k}} - {a}_{k} \cdot {mean ( I )}^{{W}_{k}} , {\sum }_{i ∈ {w}_{k}} ( {I}_{i}^{2} \cdot {a}_{k} + ϵ \cdot {a}_{k} ) = {\sum }_{i ∈ {w}_{k}} ( {I}_{i} \cdot {p}_{i} - {I}_{i} \cdot ( {mean ( p )}^{{W}_{k}} - {a}_{k} \cdot {mean ( I )}^{{W}_{k}} ) ) , {a}_{k} \cdot {\sum }_{i ∈ {w}_{k}} ( {I}_{i}^{2} + ϵ - {I}_{i} \cdot {mean ( I )}^{{W}_{k}} ) = {\sum }_{i ∈ {w}_{k}} ( {I}_{i} \cdot {p}_{i} - {I}_{i} \cdot {mean ( p )}^{{W}_{k}} ) , {a}_{k} [ {\sum }_{i ∈ {w}_{k}} {I}_{i}^{2} + {\sum }_{i ∈ {w}_{k}} ϵ - {mean ( I )}^{{W}_{k}} \cdot {\sum }_{i ∈ {w}_{k}} {I}_{i} ] = {\sum }_{i ∈ {w}_{k}} ( {I}_{i} \cdot {p}_{i} ) - {\sum }_{i ∈ {w}_{k}} {I}_{i} \cdot {mean ( p )}^{{W}_{k}} , {a}_{k} [ {mean ( {I}^{2} )}^{{W}_{k}} + ϵ - {mean ( I )}^{{W}_{k}} \cdot {mean ( I )}^{{W}_{k}} ] = {mean ( I \cdot p )}^{{W}_{k}} - {mean ( I )}^{{W}_{k}} \cdot {mean ( p )}^{{W}_{k}} .$$

According to following formulas about expectation, variance and covariance: Var(X)=E[x²]-E[X]² and Cov(X, Y)=E[XY]− E[X]. E[Y], the following may be obtained:

$${a}_{k} \cdot ( {Var ( I )}^{{W}_{k}} + ϵ ) = {Cov ( I , p )}^{{W}_{k}} , {a}_{k} = \frac{{Cov ( I , p )}^{{W}_{k}}}{( {Var ( I )}^{{W}_{k}} + ϵ} .$$

According to the embodiment, the guidance image I is the downsampled luminance Y_{DS}, and the input image is the chrominance. Therefore, the linear coefficients a and b corresponding to the chrominance value U and the linear coefficients a and b corresponding to the chrominance value V may be expressed as follows:

$${a}_{U} = \frac{{f}_{mean} ( {Y}_{DS} \cdot U ) - {f}_{mean} ( {Y}_{DS} ) \cdot {f}_{mean} ( U )}{{f}_{mean} ( {Y}_{DS}^{2} ) - {{f}_{mean} ( {Y}_{DS} )}^{2} + ϵ} ,$$

$${b}_{U} = {f}_{mean} ( U ) - {a}_{U} \cdot {f}_{mean} ( {Y}_{DS} ) ,$$

$${a}_{V} = \frac{{f}_{mean} ( {Y}_{DS} \cdot V ) - {f}_{mean} ( {Y}_{DS} ) \cdot {f}_{mean} ( V )}{{f}_{mean} ( {Y}_{DS}^{2} ) - {{f}_{mean} ( {Y}_{DS} )}^{2} + ϵ} ,$$

$${b}_{V} = {f}_{mean} ( V ) - {a}_{V} \cdot {f}_{mean} ( {Y}_{DS} ) .$$

Here, fₘₑₐₙ represents mean filtering, whose size may be configured based on needs, for example, the size of mean filtering may be 3×3 or 5×5.

In the above-mentioned guided filtering procedure, if mean filtering values of local areas are normally taken from a cache, time complexity is M×N×h×w, which is cumbersome. Here, M and N are height and width of the text image, and h and w are height and width of a filtering window.

Please refer to FIG. 4. FIG. 4 shows an implementation of mean filtering accessing by the processing module according to an embodiment. Taking a size of the filtering window as 5×5 as an example, a first value in FIG. 4 is a result of adding and multiplying 5 pixels vertically, which is stored in a cache shown in a lower part of the figure after calculation. The first value is recorded as AddNum. A second value is a value retrieved from the cache, which is recorded as SubNum. An output value is an output result, recorded as BufOut. A value of BufOut is updated as an output of a current point for each clock cycle via the following formula: BufOut=BufOut+AddNum−SubNum.

According to a feasible implementation, assuming that 8 pixels are output per clock cycle, each mean filter needs to maintain 8 groups of BufOut, and 8 values from BufOut are updated each time when corresponding AddNum and SubNum are retrieved from the cache. Nevertheless, as only one multiplier is needed to calculate AddNum, duplicated calculations are avoided, thereby reducing complexity. At the same time, an AddNum calculated for a current clock cycle is not immediately used to update a current BufOut. Instead, all updates of BufOut retrieve data from a same cache.

For further illustration, the processing module may obtain the to-be-displayed text image based on the coefficients of chrominance transformation as follows.

The coefficients of chrominance transformation are upsampled, and an output image is obtained based on the upsampled coefficients and the luminance. At this time, the output as: image q may be expressed as:

$$q = {f}_{mean} ( a ) \cdot I + {f}_{mean} ( b )$$

Accordingly, output chrominance value U and output chrominance value V may be expressed by following formulas:

$${U}_{out} = {f}_{mean} ( {a}_{U} ) \cdot Y + {f}_{mean} ( {b}_{U} ) ,$$

$${V}_{out} = {f}_{mean} ( {a}_{V} ) \cdot Y + {f}_{mean} ( {b}_{V} ) .$$

Specifically, linear coefficients a and b corresponding to the chrominance transformation are upsampled, and sizes of the linear coefficients are enlarged to a same size as the luminance.

Encoding mode of the output image is converted, and the upsampled coefficients of chrominance transformation and the luminance are substituted into the following mode conversion formula to obtain the to-be-displayed text image:

$$\{ \begin{matrix}R = Y + 1.14 * {V}_{out} \\ G = Y - 0.39 * {U}_{out} - 0.58 * {V}_{out} \\ B = Y + 2.03 * {U}_{out}\end{matrix}$$

With the above-mentioned apparatus for processing text images, the luminance and the chrominance of the initial text image are extracted after the initial text image is obtained, and linear transformation is performed on the chrominance based on the luminance, such that luminance values of the text image may be integrated into outputted chrominance values. Since there is no lack of data about the luminance values during a display process and the outputted chrominance values are not results obtained through interpolation, a ringing problem is fundamentally avoided, thereby avoiding blurring and color distortion problems caused by traditional chroma upsampling algorithms, and improving a display effect.

Modules in the above-mentioned apparatus for processing text images may be implemented in whole or in part by software, hardware, and a combination of hardware and software. The above-mentioned modules may be, in the form of hardware, embedded in a processor of a computer device or independent from the processor, or may be stored in the form of software in a memory of a computer device, so as to make it easier for the processor to call and execute operations corresponding to respective modules.

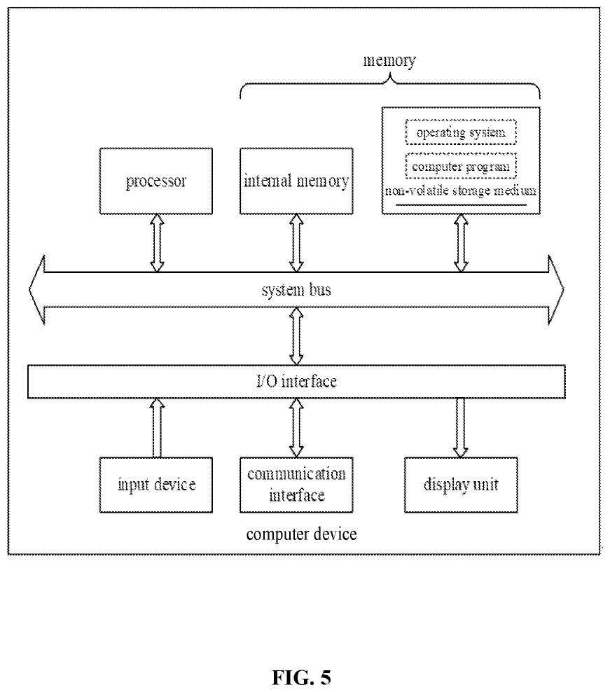

A computer device is provided according to an embodiment. The computer device may be a terminal, whose internal structure may be referred to FIG. 5. The computer device includes a processor, a memory, an input/output interface, a communication interface, a display unit, and an input device, where the processor, the memory, and the input/output interface are connected via a system bus, and the communication interface, the display unit, and the input device are connected to the system bus via the input/output interface. The processor of the computer device is configured to provide computing and control capabilities. The memory of the computer device includes non-volatile storage medium and an internal memory. The non-volatile storage medium stores an operating system and computer programs. The internal memory provides an environment for running the operating system and computer programs stored in the non-volatile storage media. The input/output interface of the computer device is used for exchanging information between the processor and external devices. The communication interface of the computer device is used for wired or wireless communication with external terminals, with wireless communication being achieved through Wi-Fi, mobile cellular networks, Near Field Communication (NFC), or other technologies. The computer program is executed by the processor to implement a method for processing text images. The display unit of the computer device is used to form a visually visible image, which may be a display screen, a projection device, or a virtual reality imaging device. The display screen may be a liquid crystal display screen or an e-ink screen. The input device of the computer device may be a touch layer covering the display screen, or may be a button, a trackball, or a touchpad disposed on a housing of the computer device, or may be an external keyboard, a touchpad, a mouse or the like.

Those of ordinary skills in the art should understand that the structure shown in FIG. 5 is only a part of a structure related to a solution of the present disclosure and does not limit the computer device to which the solution of the present disclosure is applied. Specifically, the computer device may include more or less members than those in FIG. 5, or include a combination of some members, or include different member layouts.

A computer device is provided according to an embodiment, which includes a memory and a processor. A computer program is stored in the memory. The following steps are implemented by the processor when the computer program is executed by the processor: obtaining an initial text image; extracting luminance and chrominance of the initial text image; obtaining coefficients of chrominance transformation by performing a linear transformation on the chrominance based on the luminance; and obtaining a to-be-displayed text image based on the coefficients of chrominance transformation.

According to a feasible embodiment, the following steps are further implemented by the processor when the computer program is executed by the processor: obtaining a way of sampling of the initial text image; downsampling the luminance based on the way of sampling; and obtaining the coefficients of chrominance transformation by performing the linear transformation on the chrominance based on the downsampled luminance, where a size of the downsampled luminance is the same as a size of the chrominance.

According to a feasible embodiment, the following steps are further implemented by the processor when the computer program is executed by the processor: constructing a guided filter; taking the downsampled luminance as a guidance image of the guided filter and taking the chrominance as an input image of the guided filter; calculating linear coefficients by using the guided filter based on the guidance image and the chrominance; and obtaining the coefficients of chrominance transformation by performing transformation on the chrominance based on the linear coefficients.

According to a feasible embodiment, the following steps are further implemented by the processor when the computer program is executed by the processor: performing a linear transformation on the guidance image to obtain a guided output image; obtaining a target function based on the guided output image and the chrominance; and optimizing the target function to find an optimal solution and obtaining the linear coefficients.

According to a feasible embodiment, the following steps are further implemented by the processor when the computer program is executed by the processor: upsampling the coefficients of chrominance transformation; obtaining an output image based on the upsampled coefficients and the luminance; and converting encoding mode of the output image and obtaining the to-be-displayed text image.

According to a feasible embodiment, the following steps are further implemented by the processor when the computer program is executed by the processor: upsampling the linear coefficients corresponding to the chrominance transformation and enlarging sizes of the linear coefficients to a same size as the luminance.

A computer readable storage medium is provided according to an embodiment, storing thereon a computer program. The computer program, when executed by a processor, may implement the following steps: obtaining an initial text image; extracting luminance and chrominance of the initial text image; obtaining coefficients of chrominance transformation by performing a linear transformation on the chrominance based on the luminance; and obtaining a to-be-displayed text image based on the coefficients of chrominance transformation.

According to a feasible embodiment, the following steps are further implemented when the computer program is executed by the processor: obtaining a way of sampling of the initial text image; downsampling the luminance based on the way of sampling; and obtaining the coefficients of chrominance transformation by performing the linear transformation on the chrominance based on the downsampled luminance, where a size of the downsampled luminance is the same as a size of the chrominance.

According to a feasible embodiment, the following steps are further implemented when the computer program is executed by the processor: constructing a guided filter; taking the downsampled luminance as a guidance image of the guided filter and taking the chrominance as an input image of the guided filter; calculating linear coefficients by using the guided filter based on the guidance image and the chrominance; and obtaining the coefficients of chrominance transformation by performing transformation on the chrominance based on the linear coefficients.

According to a feasible embodiment, the following steps are further implemented when the computer program is executed by the processor: performing a linear transformation on the guidance image to obtain a guided output image; obtaining a target function based on the guided output image and the chrominance; and optimizing the target function to find an optimal solution and obtaining the linear coefficients.

According to a feasible embodiment, the following steps are further implemented when the computer program is executed by the processor: upsampling the coefficients of chrominance transformation; obtaining an output image based on the upsampled coefficients of chrominance transformation and the luminance; and converting encoding mode of the output image and obtaining the to-be-displayed text image.

According to a feasible embodiment, the following steps are further implemented when the computer program is executed by the processor: upsampling the linear coefficients corresponding to the chrominance transformation and enlarging sizes of the linear coefficients to a same size as the luminance.

A computer program product is provided according to an embodiment, which includes a computer program. The computer program, when executed by a processor, may implement the following steps: obtaining an initial text image; extracting luminance and chrominance of the initial text image; obtaining coefficients of chrominance transformation by performing a linear transformation on the chrominance based on the luminance; and obtaining a to-be-displayed text image based on the coefficients of chrominance transformation.

Those of ordinary skills in the art may understand that all or some of the above-mentioned embodiments may be implemented by a computer program instructing relevant hardware. The computer program may be stored in a nonvolatile computer readable storage medium. When the computer program is executed, the execution may include processes of embodiments directed to the above-mentioned methods. Any memory, database, or other medium recited in the various embodiments provided in the disclosure may include at least one of a non-volatile memory or a volatile memory. The nonvolatile memory may include Read-Only Memory (ROM), magnetic tape, floppy disk, flash memory, optical memory, high-density embedded nonvolatile memory, Resistive Random Access Memory (ReRAM), Magnetic Random Access Memory (MRAM), Ferroelectric Random Access Memory (FRAM), Phase Change Memory (PCM), graphene memory, and the like. Volatile memory may include Random Access Memory (RAM), external cache memory, and the like. By way of illustration and not limitation, RAM may take many forms, such as Static Random Access Memory (SRAM) or Dynamic Random Access Memory (DRAM), among others. The databases referred in various embodiments provided herein may include at least one of relational databases or non-relational databases. The non-relational database may include, but is not limited to, a block chain based distributed database, and the like. The processors referred in the embodiments provided herein may be, but are not limited to, general purpose processors, central processing units, graphics processors, digital signal processors, programmable logic devices, quantum computing based data processing logic devices, and the like.

Technical features of the above-mentioned embodiments may be freely combined. To be brief in description, not all possible combinations of the technical features in the above-mentioned embodiments are described. However, the combinations of these technical features should be considered to fall within the scope of this specification as long as these combinations are not contradictory.

The above-mentioned embodiments only represent several embodiments of this disclosure, and their descriptions are specific and detailed, but should not be understood as limiting the scope of this disclosure. It should be noted that, several modifications and improvements can be made by those of ordinary skill in the art without departing from the concept of this disclosure, which belong to the protection scope of this disclosure. Therefore, it is intended that the protection scope of this disclosure shall be subjected to the appended claims.

What is claimed is:

1. A method for processing text images, comprising:
obtaining an initial text image;
extracting luminance and chrominance of the initial text image;
obtaining coefficients of chrominance transformation by performing a linear transformation on the chrominance based on the luminance; and
obtaining a to-be-displayed text image based on the coefficients of chrominance transformation.

2. The method of claim 1, wherein the obtaining the coefficients of chrominance transformation by performing the linear transformation on the chrominance based on the luminance comprises:
obtaining a way of sampling of the initial text image;
downsampling the luminance based on the way of sampling; and
obtaining the coefficients of chrominance transformation by performing the linear transformation on the chrominance based on the downsampled luminance, wherein a size of the downsampled luminance is the same as a size of the chrominance.

3. The method of claim 2, wherein the obtaining the coefficients of chrominance transformation by performing the linear transformation on the chrominance based on the downsampled luminance comprises:
constructing a guided filter;
taking the downsampled luminance as a guidance image of the guided filter and taking the chrominance as an input image of the guided filter;
calculating linear coefficients by using the guided filter based on the guidance image and the chrominance; and
obtaining the coefficients of chrominance transformation by performing transformation on the chrominance based on the linear coefficients.

4. The method of claim 3, wherein the calculating the linear coefficients based on the guidance image and the chrominance comprises:
performing a linear transformation on the guidance image to obtain a guided output image;
obtaining a target function based on the guided output image and the chrominance; and
optimizing the target function to find an optimal solution and obtaining the linear coefficients.

5. The method of claim 3, wherein the obtaining the to-be-displayed text image based on the coefficients of chrominance transformation comprises:
upsampling the coefficients of chrominance transformation;
obtaining an output image based on the upsampled coefficients of chrominance transformation and the luminance; and
converting an encoding mode of the output image and obtaining the to-be-displayed text image.

6. The method of claim 5, wherein the upsampling the coefficients of chrominance transformation comprises:
upsampling the linear coefficients corresponding to the chrominance transformation and enlarging sizes of the linear coefficients to a same size as the luminance.

7. An apparatus for processing text images, comprising a processor and a computer-readable memory where stores a computer program therein, wherein the processor, when executing the computer program, implements:
obtaining an initial text image;
extracting luminance and chrominance of the initial text image;
obtaining coefficients of chrominance transformation by performing a linear transformation on the chrominance based on the luminance; and
obtaining a to-be-displayed text image based on the coefficients of chrominance transformation.

8. The apparatus of claim 7, wherein the obtaining the coefficients of chrominance transformation by performing the linear transformation on the chrominance based on the luminance comprises:
obtaining a way of sampling of the initial text image;
downsampling the luminance based on the way of sampling; and
obtaining the coefficients of chrominance transformation by performing the linear transformation on the chrominance based on the downsampled luminance, wherein a size of the downsampled luminance is the same as a size of the chrominance.

9. The apparatus of claim 8, wherein the obtaining the coefficients of chrominance transformation by performing the linear transformation on the chrominance based on the downsampled luminance comprises:
constructing a guided filter;
taking the downsampled luminance as a guidance image of the guided filter and taking the chrominance as an input image of the guided filter;
calculating linear coefficients by using the guided filter based on the guidance image and the chrominance; and
obtaining the coefficients of chrominance transformation by performing transformation on the chrominance based on the linear coefficients.

10. The apparatus of claim 9, wherein the calculating the linear coefficients based on the guidance image and the chrominance comprises:
performing a linear transformation on the guidance image to obtain a guided output image;
obtaining a target function based on the guided output image and the chrominance; and
optimizing the target function to find an optimal solution and obtaining the linear coefficients.

11. The apparatus of claim 9, wherein the obtaining the to-be-displayed text image based on the coefficients of chrominance transformation comprises:
upsampling the coefficients of chrominance transformation;
obtaining an output image based on the upsampled coefficients of chrominance transformation and the luminance; and
converting an encoding mode of the output image and obtaining the to-be-displayed text image.

12. The apparatus of claim 11, wherein the upsampling the coefficients of chrominance transformation comprises:
upsampling the linear coefficients corresponding to the chrominance transformation and enlarging sizes of the linear coefficients to a same size as the luminance.

13. A computer readable storage medium, which stores a computer program thereon, wherein the computer program, when executed by a processor, causes the processor to perform:
obtaining an initial text image;
extracting luminance and chrominance of the initial text image;
obtaining coefficients of chrominance transformation by performing a linear transformation on the chrominance based on the luminance; and
obtaining a to-be-displayed text image based on the coefficients of chrominance transformation.

14. The computer readable storage medium of claim 13, wherein the obtaining the coefficients of chrominance transformation by performing the linear transformation on the chrominance based on the luminance comprises:
obtaining a way of sampling of the initial text image;
downsampling the luminance based on the way of sampling; and
obtaining the coefficients of chrominance transformation by performing the linear transformation on the chrominance based on the downsampled luminance, wherein a size of the downsampled luminance is the same as a size of the chrominance.

15. The computer readable storage medium of claim 14, wherein the obtaining the coefficients of chrominance transformation by performing the linear transformation on the chrominance based on the downsampled luminance comprises:
constructing a guided filter;
taking the downsampled luminance as a guidance image of the guided filter and taking the chrominance as an input image of the guided filter;
calculating linear coefficients by using the guided filter based on the guidance image and the chrominance; and
obtaining the coefficients of chrominance transformation by performing transformation on the chrominance based on the linear coefficients.

16. The computer readable storage medium of claim 15, wherein the calculating the linear coefficients based on the guidance image and the chrominance comprises:
performing a linear transformation on the guidance image to obtain a guided output image;
obtaining a target function based on the guided output image and the chrominance; and
optimizing the target function to find an optimal solution and obtaining the linear coefficients.

17. The computer readable storage medium of claim 15, wherein the obtaining the to-be-displayed text image based on the coefficients of chrominance transformation comprises:
upsampling the coefficients of chrominance transformation;
obtaining an output image based on the upsampled coefficients of chrominance transformation and the luminance; and
converting an encoding mode of the output image and obtaining the to-be-displayed text image.

18. The computer readable storage medium of claim 17, wherein the upsampling the coefficients of chrominance transformation comprises:
upsampling the linear coefficients corresponding to the chrominance transformation and enlarging sizes of the linear coefficients to a same size as the luminance.
